(19) United States
(12) Patent Application Publication
(10) Pub. No.: US 2026/0271155 A1
(43) Pub. Date: Sep. 10, 2026

(54) HIGH EFFICIENCY DIMMING WITH MULTIPLE SUB-DRIVERS FOR A SINGLE LOAD

(71) Applicant: SIGNIFY HOLDING B.V., EINDHOVEN (NL)

(72) Inventors: HAIMIN TAO, EINDHOVEN (NL); WERNER FRIEDRICH HORIKX, EINDHOVEN (NL)

(21) Appl. No.: 19/166,132

(22) PCT Filed: Mar. 13, 2024
(86) PCT No.: PCT/EP2024/056715

§ 371 Date: Sep. 17, 2025

(30) Foreign Application Priority Data
Mar. 21, 2023 (EP) 23163301.7

(51) Int. Cl. H05B 45/3725; H05B 45/10

(52) U.S. Cl. CPC H05B 45/3725; H05B 45/10

(57) ABSTRACT

The invention relates to a driver circuit for driving a light source. The driver circuit comprises a first driver adapted to provide power to the light source, a second driver adapted to provide power to the light source and a controller for controlling the first driver and the second driver. The controller is arranged to receive a dimming signal indicative of a dimming level for the light source, wherein the controller is arranged to convert the received dimming signal into a discrete number of dimming levels representing dimming levels corresponding to an amount of power that can be provided by the first driver and/or the second driver, wherein the controller is arranged to allow or deny a power to flow from the first driver and/or the second driver based on the discrete dimming level.

### FIELD OF THE INVENTION

The invention relates to a driver. The invention further relates to a lighting apparatus.

### BACKGROUND OF THE INVENTION

For the lighting industry, the requirements for energy efficiency become more challenging, especially with the new European Union energy labelling introduced on 1 Sep. 2021. This new labelling follows the trend of improvements in energy efficiency for lighting products. By then, more and more light sources achieved label ratings of A+ or A++, making it impossible for customers to see any light efficiency difference between products. With the new labelling, the light sources become more distributed over the labelling range again. This also means that lamps that were for example A++ rated in the old system are now labelled as C. It is therefore desired to further improve the energy efficiency of light sources.

Especially at dimmable light sources, there is a great desire to improve the efficiency. At dimming and especially deep dimming, the fixed losses in a driver e.g., losses caused in the control circuit, become a dominant part of the losses in a lighting apparatus. Drivers are generally designed for their rated power and the fixed losses are therefore also depending on the rated power of the driver. In general, a driver with a lower rated output power has also lower fixed power losses. This obviously impacts the total amount of power that can be provided to the load. A driver with a higher rated power can provide more power to its output, but this comes with more fixed losses. It is therefore desired to provide a lighting apparatus that can provide a good dimming function while operating at a very high efficiency.

### SUMMARY OF THE INVENTION

It is an objective of the invention to provide a solution that allows dimming to be performed while maintaining a good overall efficiency.

To provide such solution, in a first aspect of the invention, a driver circuit for driving a light source is provided. The driver circuit comprises:
a first driver adapted to provide a first maximum amount of power to the light source;
a second driver adapted to provide a second maximum amount of power to the light source;
a controller for controlling the first driver and the second driver;
wherein the controller is arranged to receive a dimming signal indicative of a dimming level for the light source,
wherein the controller is arranged to convert the received dimming signal into a discrete number of dimming levels representing dimming levels corresponding to the first maximum amount of power provided by the first driver and/or to the second maximum amount of power provided by the second driver, wherein the controller is arranged to allow or deny a power to flow from the first driver and/or the second driver based on the received dimming signal.

A first driver and a second driver are provided. Both drivers provide power to the same light source. A controller is used for controlling the first and second driver. The controller also receives a dimming signal. The dimming signal may be any kind of dimming signal that is used in the lighting industry. Examples of dimming signals are phase-cut dimming signals, 0-10 V dimming signals, DALI dimming signals, DMX dimming signals or wireless dimming signals. The controller translates the received dimming signal into a number of discrete dimming levels. The discrete diming level is an indication of the amount of power that is to be provided to the light source. Based on the discrete dimming level, the controller determines which of the drivers is allowed to provide power to the light source. Based on the discrete dimming level, the controller may decide to provide power to the light source using the first driver, the second driver or the first driver and the second driver. Preferably, the number of discrete dimming levels is based in the number of drivers. If there are two drivers, there may be three discrete dimming levels, in the event that both drivers have the same rated powers. Such dimming levels may then e.g. be: 0%, 50% and 100%. At 0%, the controller may decide to deny both drivers to power the light source. At 50%, the controller may decide to allow only one of the drivers to power the light source. At 100%, the controller may decide to allow both drivers to power the light source. In this example, it may be preferred that the discrete dimming levels are set at the rated powers of the corresponding drivers. Preferably, the drivers have the highest efficiency at the corresponding rated power. As an example, when both the first driver and the second driver are arranged to provide 2 W of power to the light source, the 50% discrete dimming level corresponds to 2 W of power to the light source. The 100% discrete dimming level may then correspond to 4 W of power to the light source. At any of the discrete dimming levels, the driver circuit may allow an optimized power efficiency to be achieved.

In a further example, the driver circuit further comprises a third driver, wherein the controller is arranged to control the third driver and wherein each discrete dimming level represents a dimming level corresponding to an amount of power that can be provided by the first driver and/or the second driver and/or the third driver, wherein the controller is arranged to allow or deny a power to flow from the first driver and/or the second driver and/or the third driver based on the discrete dimming level.

A third driver allows more discrete diming steps to be provided. If there are three drivers, there may be four discrete dimming levels, in the event that all drivers have the same rated powers. Such dimming levels may then e.g. be: 0%, 33%, 66% and 100%. Preferably, the drivers have the highest efficiency at the corresponding rated power. As an example, when the first driver, the second driver and the third driver are arranged to provide 2 W of power to the light source, the 33% discrete dimming level corresponds to 2 W of power to the light source. The 66% discrete dimming level may then correspond to 4 W of power to the light source. The 100% discrete dimming level may then correspond to 6 W of power to the light source. At any of the discrete dimming levels, the driver circuit may allow an optimized power efficiency to be achieved.

In a further example, the first driver and the second driver are arranged to have identical rated powers.

If the first driver and the second driver provide a substantial similar amount of power to the light source, the drivers may be designed as identical modules. This greatly simplifies the design of the driver circuit. In this example, the number of discrete dimming steps may be based on the number of drivers used. Each additional driver allows an additional discrete dimming step to be introduced. In addition, the 0% dimming level is always present. In that sense, the amount of discrete dimming level may be derived from the following equation: D=1+N, where D is the number of discrete dimming levels and N is the number of drivers.

In a further example, the first driver and the second driver are arranged to have different rated powers from each other.

Using drivers with different rated powers allow more dimming steps to be provided. If there are two drivers, there may be four discrete dimming levels. Additionally, different dimming steps can be provided in a non-linear way, e.g. logarithmic dimming curve.

As an example, the first driver may provide a power of 1 W to the light source and the second driver may provide a power of 2 W to the light source. This may result in dimming levels of e.g. be: 0%, 33%, 66% and 100%. This would result in that 33% discrete dimming level corresponds to 1 W of power to the light source. The 66% discrete dimming level may then correspond to 2 W of power to the light source. The 100% discrete dimming level may then correspond to 3 W of power to the light source. In that sense, the amount of discrete dimming levels may be derived from the following equation.

$$D = \frac{N ( N + 1 )}{2} + 1 ,$$

where D is the number of discrete dimming levels and N is the number of drivers. In the example of three drivers, seven combinations are possible.

In a further example, between two discrete dimming steps, only one driver is arranged to provide a variable power to the light source.

It is preferred that in between two discrete dimming steps, only one driver may provide a varying power to the light source. This could mean that e.g. the first driver provides a fixed amount of power to the light source, preferably at the rated power of the first driver. Preferably, the second driver may then additionally provide a power to the light source that may vary based on the dimming signal. By providing a fixed amount of power to the light source, preferably at the rated power of the first driver with or close to the highest efficiency, the first driver operates at the highest efficiency. The second driver may operate at an efficiency that may be lower. The overall efficiency of the driver circuit is however still improved, while the second driver allows for more dimming levels. In the example of three drivers, the first driver and the second driver may provide a fixed amount of power to the light source, preferably at the rated powers of the first and second drivers with or close to the highest efficiency. The third driver may then additionally provide a power to the light source that may vary based on the dimming signal. Another example with three drivers may be that the first driver provides a fixed amount of power to the light source, preferably at the rated power of the first driver. The second driver may then additionally provide a power to the light source that may vary based on the dimming signal. In this example, the third driver does not provide power to the light source. The determination of the control of the drivers as defined in the previous examples may be based on the dimming signal and/or the discrete dimming level. Between two discrete steps, the controller can provide additional dimming steps, which allows the driver that provides the variable power to the light source to change its output power according to the dimming signal.

In a further example, the first driver and/or the second driver are non-dimmable.

If the drivers are non-dimmable, the drivers are arranged to provide a fixed amount of power. The drivers can therefore only provide one power level, which may be at the rated power of the drivers. The drivers have an optimum power efficiency since the drivers are optimized in the design to provide this single amount of power at an efficiency as high as possible. In this example, when all the drivers are non-dimmable, the driver circuit may only be able to provide the discrete dimming steps available corresponding to the number of drivers provided.

In a further example, wherein the controller is arranged for turning on and off the first driver and the second driver based on the discrete dimming level.

A simple way of allowing and denying power to be provided from the drivers to the light source is to turn the corresponding driver on and off. When the controller decides that, based on the discrete dimming level, a driver should not provide power to the light source, the controller turns the corresponding driver off. If the discrete dimming level increase, the controller may decide to turn on the corresponding driver. An advantage of turning off a driver is that this driver is consuming less or no power during the turn off period. This greatly increases the efficiency of the corresponding driver and therefore the driver circuit.

In a further example, the first driver and/or the second driver are dimmable, wherein the first driver and/or the second driver are adapted to be dimmed down to a minimum output power of 50%. Preferably, the first driver and/or the second driver cannot be dimmed down below this minimum output power of 50%. Below this level of output power, the efficiency of the drivers may begin to reduce significantly and therefore further dimming down will have a too large impact on the efficiency of the driver circuit.

The drivers may be designed to operate at an optimum efficiency at a rated power of 100% output power. If the drivers deviate from this power point, the efficiency will go down. If both or one of the drivers reduces its output power below 50%, the impact of the driver circuit may become too much and is therefore not desired. The drivers should therefore be arranged such that the output power can not drop below 50%.

In a further example, the first driver and/or the second driver are dimmable switched mode power supplies wherein the first driver and/or the second driver are adapted to be dimmed down such that a total efficiency of the driver circuit does not fall below 95%.

To ensure a good overall efficiency of the driver circuit, it is desired to avoid the total efficiency to drop below 95%. This would mean that the drivers are designed for powering the light source such that the total efficiency does not drop below 95%. This could mean for example that the drivers are not allowed to dim such that the total efficiency drops below 95%. The input power and the output power can be measured, allowing the controller to determine what the efficiency of the driver circuit is.

In a further example, the driver circuit comprises an auxiliary driver, adapted to power the controller and adapted to be electrically separated from the light source.

The controller normally requires its own power supply. The controller has its own power requirements. It is therefore desired to provide an auxiliary driver that has its power efficiency optimized for the power consumed by the controller. This can be done when the auxiliary driver is used for only powering the controller. It is preferred to electrically separate the auxiliary driver from the light source so that the auxiliary driver is unable to power the light source.

In a further example, the driver circuit comprises a further auxiliary driver, wherein the further auxiliary driver is adapted to power the controller when the driver circuit is in a standby mode.

In standby, the controller may consume a lower power than during normal operation. It is preferred to also provide a good power efficiency during a standby mode of the driver circuit. A further auxiliary driver may have its power efficiency optimized for the power consumed by the controller during standby. During standby, the controller may e.g. still be active for receiving wireless control signals.

In a further example, at a discrete dimming level, where the first driver and the second driver provide power to the lighting load, the first driver and the second driver operate in an interleaved mode of operation.

It is desired to have at a discrete dimming level, where both drivers provide power at their optimized power efficiency, that the drivers operate in an interleaved operation mode. The controller can control the two drivers such that they operate with a relative phase delay. The phase delay is preferably 180 degrees when two drivers are used or 360°/n for any number of n drivers. This results in a ripple in the output current with a double frequency but with a reduced peak-peak amplitude.

In another example, a lighting apparatus is provided. The lighting apparatus comprises a driver circuit according to any of the preceding examples and the light source.

A lighting apparatus will benefit from a driver circuit according to the invention. The lighting apparatus can provide a dimmed light output from its light source while maintaining a good efficiency.

In another example, the controller is arranged to control the first driver and the second driver based on the dimming level such that an efficacy of the lighting apparatus increases when the dimming level decreases.

Preferably, the efficacy of the lighting apparatus increases. This can be done by turning one driver off when the discrete dimming level is at a level that e.g. only one driver is required for powering the light source. The light source is configured to receive then only the current from the first driver, while no current is provided by the second driver. This means that less current is provided to the light source, resulting in a reduced current density in the light source. The light source has an improved efficacy at a reduced current density and therefore the efficiency of the lighting apparatus is improved.

In another example, the lighting load is a semiconductor lighting load, preferably an LED load, more preferably in the form of a filament.

Preferably, the lighting load is a semiconductor lighting load. Examples of semiconductor loads are LEDs, laser diodes and vertical-cavity surface-emitting lasers, VCSEL. Preferably, the LEDs are formed as a filament.

### BRIEF DESCRIPTION OF THE DRAWINGS

Examples of the invention will now be described with reference to the accompanying drawings, in which:

FIG. 1 shows an example of a circuit diagram.

FIG. 2 shows another example of a circuit diagram.

FIG. 3 shows a graph of a relation between output power and dimming level.

FIG. 4 shows another graph of a relation between output power and dimming level.

FIG. 5 shows another graph of a relation between output power and dimming level.

FIG. 6 shows another graph of a relation between output power and dimming level.

FIG. 7 shows another example of a circuit diagram.

FIG. 8 shows another graph of a relation between output power and dimming level.

FIG. 9 shows another graph of a relation between output power and dimming level.

FIG. 10 shows another graph of a relation between output power and dimming level.

FIG. 11 shows another example of a circuit diagram.

FIG. 12 shows another example of a circuit diagram.

FIG. 13 shows an example of a light source.

FIG. 14 shows another example of a circuit diagram.

FIG. 15 shows another example of a circuit diagram.

FIG. 16 shows another example of a circuit diagram.

### DETAILED DESCRIPTION OF THE EMBODIMENTS

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should also be understood that the Figures are merely schematic and are not drawn to scale. It should also be understood that the same reference numerals are used throughout the Figures to indicate the same or similar parts.

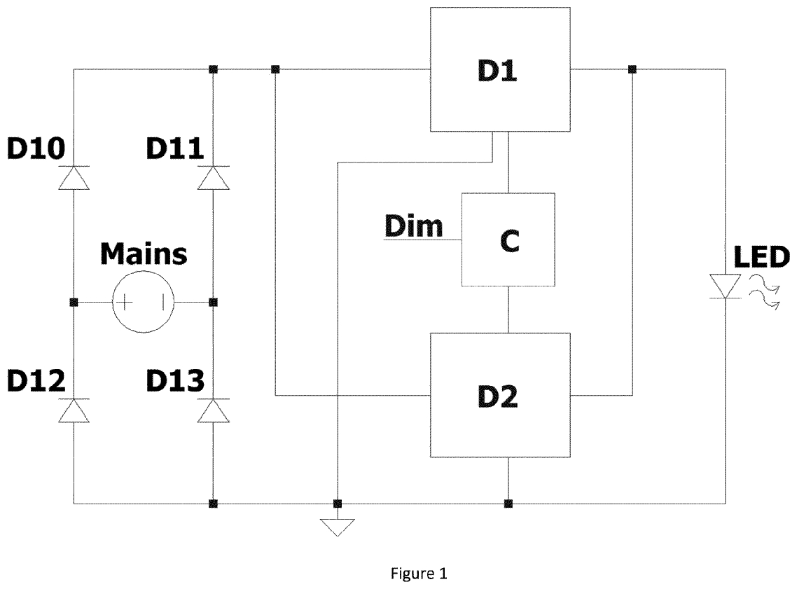

FIG. 1 shows an example of a circuit diagram of a lighting apparatus having a driver circuit that provides an output power to the light source LED. The driver circuit may be coupled to mains via a rectifier circuit having four diodes D10, D11, D12 and D13. The rectifier circuit provides a rectified mains voltage. In the example provided, a first driver D1 and a second driver D2 receive the rectified mains voltage. A controller C is used to control the first driver D1 and the second driver D2. The controller C may receive a dimming signal Dim. The dimming signal Dim may be provided by a dimmer or an external device providing dimming commands. Examples of devices that can provide the dimming signal are phase-cut dimmers, 0-10 V dimmers, DALI dimmers, DMX dimmers or wireless remote devices for providing dimming signals. The first driver D1 and the second driver D2 are arranged to provide power to the same load, which is in this example a light source LED.

The light source LED has a first input to which the output of the first driver D1 and the output of the second driver D2 are coupled. Preferably, the light source LED is an LED light source. The LED light source may be a string of LEDs coupled in series, preferably forming a filament. Other devices or a combination of devices may also be coupled in series such as laser diodes or VCSEL. For the sake of clarity, the examples show LEDs as the light source. Preferably, the size of the LED string cannot be changed. This means that the LED string has only one input and one return for receiving a current and returning the current respectively. The forward voltage can therefore not be altered by e.g. a shunt switch shunting a part of the LED string. This way, the power consumed by the light source LED is regulated by the drivers powering the light source LED and not by changing the size of the light source LED. The light source LED may have two LED strings in parallel, preferably having approximately the same forward voltage. More details on this topology will be provided in further examples.

The controller C receives the dimming signal and uses this dimming signal for providing control signals for the first driver D1 and the second driver D2. Preferably, the controller C converts the dimming signal into discrete dimming levels. The controller C may base the number of discrete dimming levels on the number of drivers provided in the driver circuit. In the example of drivers having identical rated powers, the number of discrete dimming levels may be determined by the equation: D=1+N, where D is the number of discrete dimming levels and N is the number of drivers. In the example where two drivers are provided, the number of discrete dimming levels is 3. The dimming signal has a dimming range from 0% to 100%. The controller C reads the dimming signal and based on the value of the dimming signal, discrete dimming levels are generated. The discrete dimming levels are then set at 0% output power, 50% output power and 100% output power. In this example, a dimming signal between 0% and 25% may be converted into 0% as a discrete dimming level. A dimming signal between 26% and 75% may be converted into 50% as a discrete dimming level. A dimming signal between 76% and 100% may be converted into 100% as a discrete dimming level. It is clear that these values are merely one example of how to convert the dimming range of the dimming signal into discrete dimming levels and that other ranges for converting the dimming signal into the discrete dimming levels are conceivable. At 0% output power, the controller provides control signals to the drivers preventing the first driver D1 and the second driver D2 to provide power to the light source LED. Both drivers may be turned off. At 50% of the output power, the controller C provides control signals to the drivers allowing one of the drivers to provide the rated power to the load and preventing the other driver to provide power to the load. At 100% of the output power, the controller C provides control signals to the drivers allowing both drivers to provide their rated power to the light source.

At all discrete dimming levels, the lighting apparatus is now capable of operating at the highest efficiency possible. When less than the maximum number of drivers provide power to the light source LED, the light efficacy may even further be improved. Since the light source has a single forward voltage that cannot be changed in magnitude by e.g. shunting a part of the series connection of the LEDs in the light source, the number of drivers providing power to the light source determine the current density in the light source LED. Less drivers powering the light source LED reduces the current density through the light source LED, and therefore increase the light efficacy of the lighting apparatus.

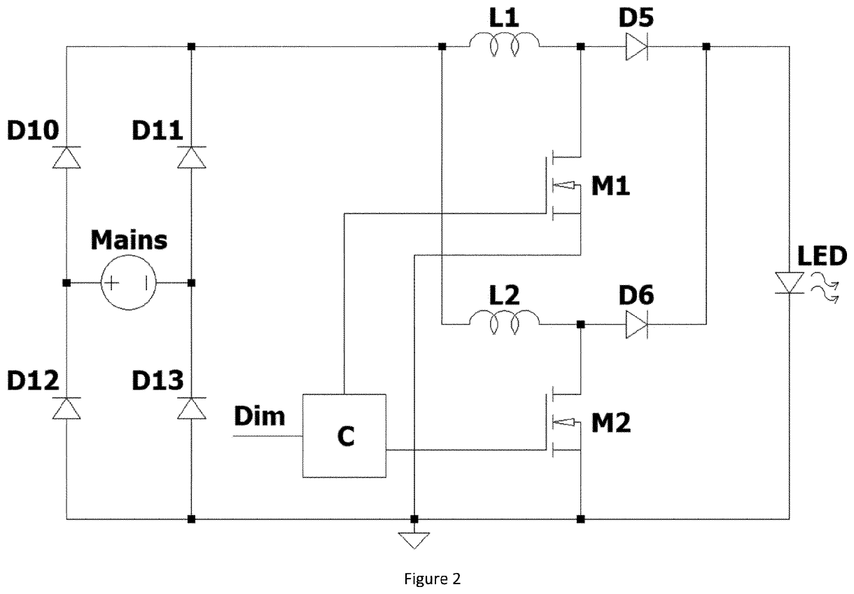

FIG. 2 shows an example of a detailed circuit diagram of the circuit shown in FIG. 1. In the example provided, a rectifier circuit D10, D11, D12, D13 is provided. The rectifier circuit provides a rectified voltage which is provided to the first driver D1 and the second driver D2. The first driver D1 and the second driver D2 are designed as boost converters. The first driver D1 and the second driver D2 are coupled in parallel at their inputs and provide a parallel power to the light source LED. The first driver D1 has a first inductor L1, a first switching element M1 and a first diode D5. The second driver D2 has a second inductor L2, a second switching element M2 and a second diode D6. The first diode D5 and second diode D6 provide two functions. The diodes form the freewheel diodes for the boost converter topology and they allow the outputs of the first driver D1 and the second driver D2 to be coupled together. In the case that another topology than the boost converter, e.g. a buck converter, an additional diode may be needed for each driver to allow the drivers to be coupled at their outputs. The controller C provides control signals for the first driver D1 and the second driver D2. In this example, the control signals may be directly provided at the gate of the first switching element M1 and the second switching element M2 respectively. The controller C therefore determines the power that can be delivered to the light source LED. Preferably, the controller C controls the drivers such that the power provided to the light source LED corresponds to power required for the light source LED according to the discrete dimming levels.

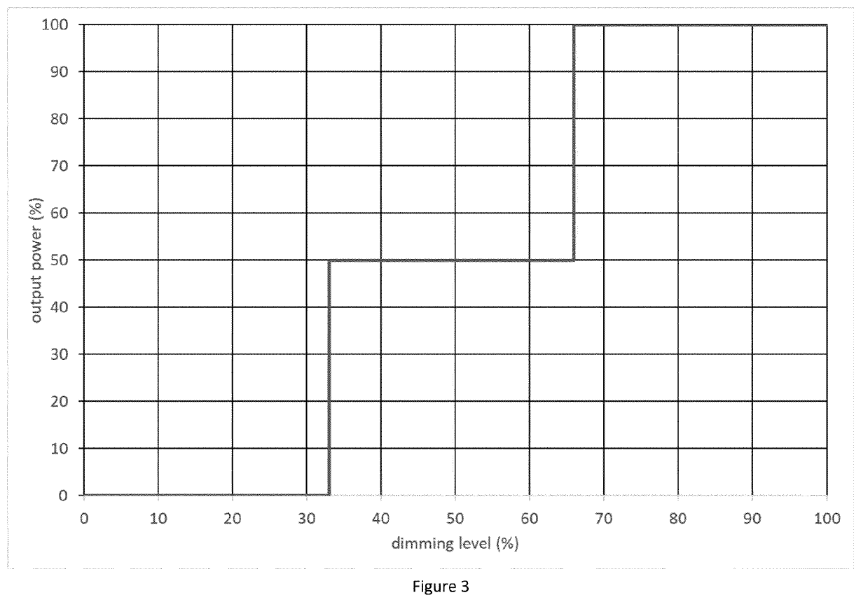

FIG. 3 shows a graph of the relation of the dimming level and the output power of the driver circuit when two drivers, having approximately equal power ratings, are provided. The dimming signal is received by the controller C and is interpreted as a dimming level. The controller determines the discrete dimming levels based on the dimming level. In this example it can be seen that there are three discrete dimming levels, one at 0% output power, one at 50% output power and the last one at 100% output power. In this example, the controller C determines that between a dimming level of 0% and 33%, the discrete dimming level is set at 0% output power. Between a dimming level of 34% and 66%, the discrete dimming level is set at 50%. Between 67% and 100%, the discrete dimming level is set at 100%. This means that in the dimming range of 0% and 33%, no power is provided to the light source LED. Between a dimming level of 34% and 66%, 50% output power is provided to the light source LED. The controller C activates one driver to provide the rated power to the light source LED, corresponding to the 50% output power, and inhibits the other driver to power the light source LED. Between a dimming level of 67% and 100%, 100% of the output power is provided to the light source LED. The controller C activates both drivers to provide their rated powers to the light source LED, which corresponds to 100% of the output power. It is clear that other relations between the dimming level and the discrete dimming levels can be derived, while keeping the same discrete dimming levels.

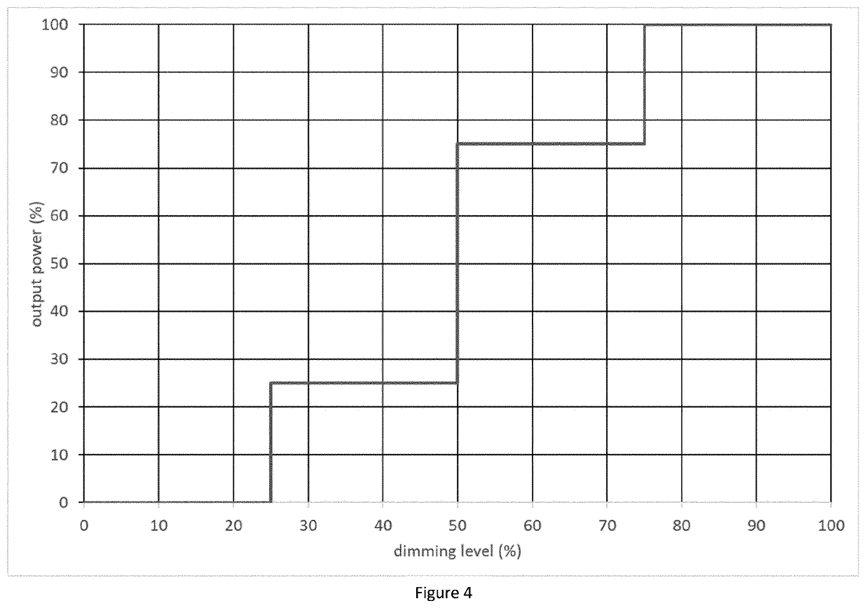

FIG. 4 shows a graph of the relation of the dimming level and the output power of the driver circuit when two drivers, having different power ratings, are provided. The dimming signal is received by the controller C and is interpreted as a dimming level. The controller C determines the discrete dimming levels based on the dimming level. In this example it can be seen that there are four discrete dimming levels, one at 0% output power, one at 25% output power, one at 75% output power and the last one at 100% output power. The number of discrete dimming levels may be derived from the equation

$$D = \frac{N ( N + 1 )}{2} + 1 ,$$

where D is the number of discrete dimming levels and N is the number of drivers. As an example, the first driver D1 is arranged to have a rated power of 1 W and the second driver D2 is arranged to have a rated power of 3 W. When both drivers are not providing power to the light source LED, the power to the light source LED is 0 W, which is related to a dimming level between 0% and 24%. When only the first driver D1 provides power to the light source LED at its rated power, the light source LED receives 1 W, which corresponds to 25% of the total output power. This output power is then related to a dimming level between 25% and 50%. When only the second driver D2 provides power to the light source at its rated power, the light source LED receives 3 W, which corresponds to 75% of the total output power. This output power is then related to a dimming level between 51% and 75%. The total rated power of the driver circuit Is 4 W, which corresponds to the output power at a dimming level between 76% and 100%, where both the first driver D1 and the second driver D2 provide power to the light source LED at their respective rated powers.

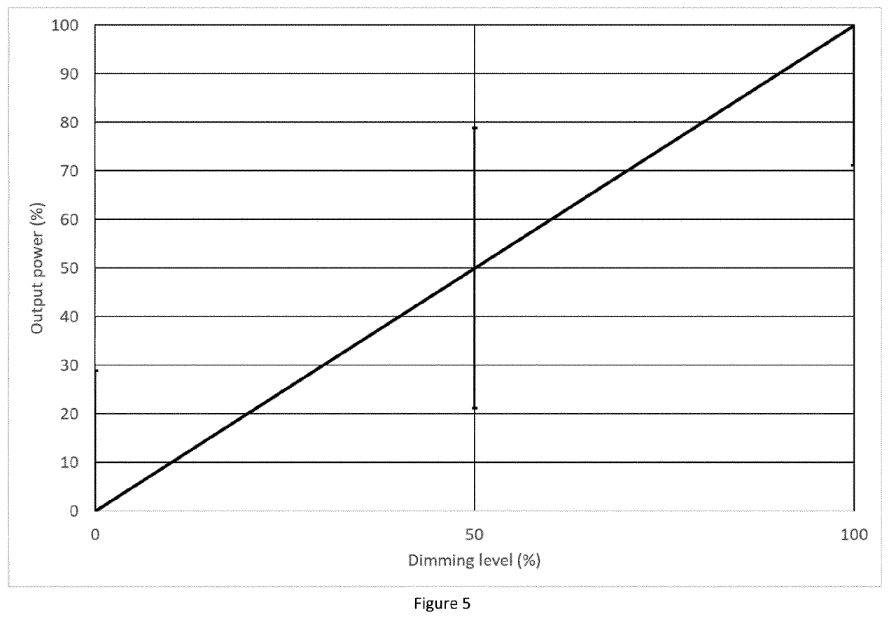

FIG. 5 shows another graph of the relation of the dimming level and the output power of the driver circuit when two drivers are provided. The dimming signal is received by the controller C and is interpreted as a dimming level. The controller determines the discrete dimming levels based on the dimming level. In this example there are three discrete dimming levels, one at 0% output power, one at 50% output power and the last one at 100% output power. In this example, the discrete dimming level is used differently compared to the previous examples. The discrete dimming level is used to determine whether an additional driver is required to provide power to the light source or if another driver is to be prevented for powering the light source. In this example, it is again assumed that the first driver D1 and the second driver D2 are arranged to have substantial identical rated powers. At 0%, the controller C controls both drivers to not provide power to the light source LED. At a dimming level between e.g. 0.1% to 50%, the controller C controls one of the drivers to allow power to be provided to the light source LED. Instead of providing power at a single rated power level, the power if the single active driver is set to follow the dimming signal and therefore the dimming level. As an example, at a dimming level of 10%, the active driver may be arranged to provide an output power of 20% of the driver's rated power and at 50%, the active driver may be arranged to provide an output power of 100% of the driver's rated power. At 50.1%, the controller C determines that the discreet dimming level of 50% has been exceeded. This means that between the dimming levels 50.1% and 100%, one of the drivers provides the rated power of the driver and the other driver additionally provides a variable power. As an example, at a dimming level of 60%, one driver provides 100% of the rated power and the driver providing variable power may be arranged to provide an output power of 20% of the driver's rated power. At a dimming level of 100%, both drivers may be arranged to provide an output power of 100% of the driver's rated power. The controller C therefore determines the discrete dimming levels and between two discrete dimming levels, one driver is arranged to provide a power to the light source LED that may be variable i.e., the power may be changed based on the dimming level, and another driver is arranged to provide a fixed power to the light source LED, preferably at the rated power of the driver.

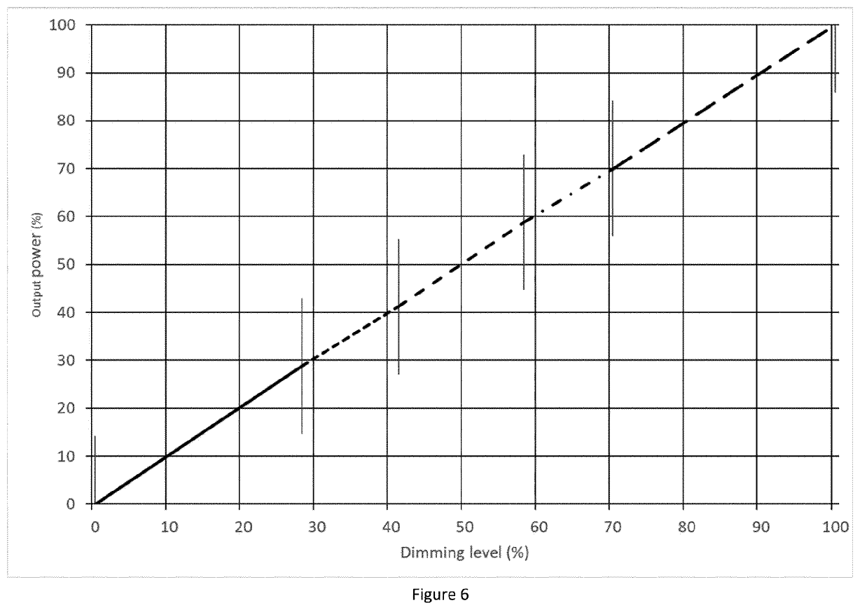

FIG. 6 shows a graph that is similar to that of the graph shown in FIG. 5. In this example, the rated powers of the two driver are chosen carefully. This rated power of the drivers is dependent on the minimum efficiency that the drivers are allowed to have. The drivers are allowed to provide a variable level from the rated power down to a power level corresponding to the lowest allowable efficiency. The first driver D1 has a rated power at 100% power output and has therefore a power range of 100% to P_{rated D1}*min_loading, where P_{rated D1} is the rated power of the first driver D1 and min_loading is the minimum allowable power of the first driver D1 in percentage where minimum driver efficiency target is met. To provide a smooth dimming curve, the minimum power that the second driver D2 can provide is equal to or lower than the rated power of the first driver D1. The rated power of the second driver D2 is then determined by

$${P}_{rated D 2} = \frac{{P}_{rated D 1}}{min\_loading} ,$$

where P_{rated D2} is the rated power of the second driver D2, P_{rated D1} the rated power of the first driver D1 and min_loading is the minimum allowable power of the second driver D2 in percentage where minimum driver efficiency target is met.

As an example, the first driver D1 and the second driver D2 have a minimum allowable loading at 70% where the minimum driver efficiency target is met. The first driver D1 may have a rated power of 1.75 W. The minimum power that may be provided by the first driver D1 is then 1.23 W. The second driver D2 is then configured to provide a minimum power of 1.75 W. This results in a rated power of 2.5 W. A total of 4.25 W can be provided by the driver circuit. The minimum power that can be provided by the first driver D1 i.e., 1.23 W, is located at 28.8% of the dimming range. The rated power that can be provided by the first driver D1 i.e., 1.75 W is located at 41.2% of the dimming range. This is therefore also the same as for the minimum power that can be provided by the second driver D2. The rated power that can be provided by the second driver D2 i.e., 2.5 W is located at 58.8% of the dimming range. The rated power of the driver circuit i.e., 4.25 W is located at 100% of the dimming range.

The first part of the graph, solid line, is a zone where in this configuration no power can be provided to the light source LED. The controller C may then prevent both drivers from powering the light source LED. Increasing the dimming level up to 28.2% will cause the controller C to turn on the first driver D1 to provide 1.23 W at 70% loading to the light source LED. Further increasing the dimming level will allow the first driver D1 to provide more power to the light source LED. If the dimming level is further increased to 41.2%, the first driver D1 is providing power to the light source LED at its rated power, and therefore preferably also at its highest efficiency. Further increasing the dimming level above 41.2% causes the second driver D2 to provide power of at least 1.75 W to the light source LED of 41.2%. In this situation, the first driver D1 is prevented from powering the light source LED. Further increasing the dimming level will allow the second driver D2 to provide more power to the light source LED. If the dimming level is further increased to 58.8%, the second driver D2 is providing power to the light source LED at its rated power, and therefore preferably also at its highest efficiency. Increasing the dimming level above 58.8% will cause the controller C to control both drivers to power the light source LED. In this case, to minimize a gap in the dimming range, the second driver D2 provides a reduced power to the light source LED, allowing the first driver D1 to also provide power to the light source. The gap may be caused by the first driver D1 not being able to provide a power below 70% loading, effectively resulting in a dimming range between 58.8% to 70%, where no increase in output power can be provided. Preferably, in this dimming range, the output power to the light source LED remains at 2.5 W. When the dimming level further increases above 70%, both drivers can start providing power to the light source LED. At 70%, both drivers can provide their lowest allowable powers of 1.23 W for the first driver D1 and 1.75 W for the second driver D2. The power at 70% provided to the light source LED is then 2.98 W. In this example, the gap in the dimming range between 58.8% and 70% relates to a power gap of 2.98 W−2.5 W=0.48 W. From a dimming level between 70% and 100%, the drivers increase their powers to the light source LED to match the corresponding dimming level. This can be done by increasing the powers of both drivers simultaneously or by increasing the power from the first driver D1 over a first part of the 70% to 100% dimming range and increasing the power from the second driver D2 over a second part of the 70% to 100% dimming range. At a dimming level of 100%, the first driver D1 and the second driver D2 provide their rated powers to the light source LED. In this example, a total power of 1.75 W+2.5 W=4.25 W is provided to the light source LED.

To reduce any gaps in the dimming range, the first driver D1 and/or the second driver D2 may be allowed to provide power down to a much lower level than 70%. In the example provided, the gap in the dimming range between 58.8% and 70% may be reduced or even removed. In the example provided, the gap in the dimming range between 0% and 28.8% may then also be reduced or removed. This may come to an expense of some efficiency loss since the efficiency of the drivers may be further reduced.

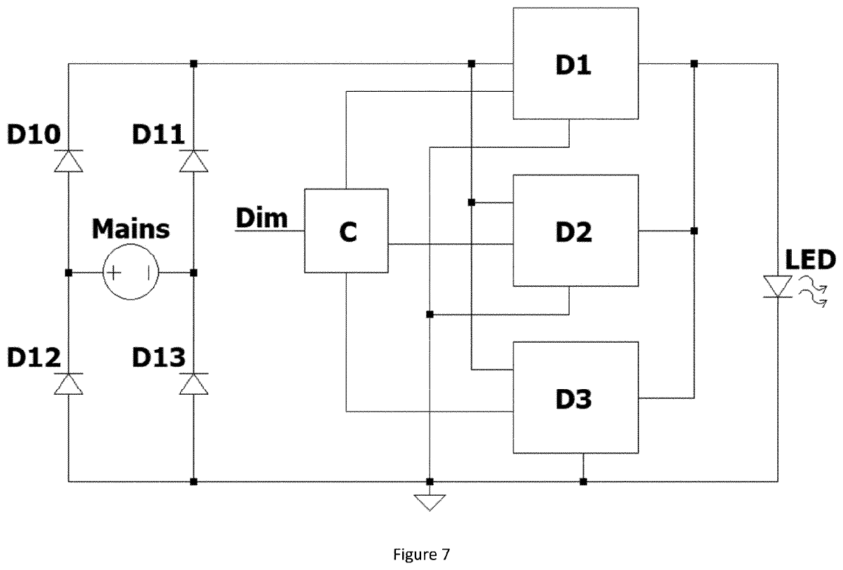

FIG. 7 shows an example of a circuit diagram of a lighting apparatus having a driver circuit. The driver circuit has an additional driver. The driver circuit has a first driver D1, a second driver D2 and a third driver D3. In the example provided, a rectifier circuit D10, D11, D12, D13 is provided. The rectifier circuit provides a rectified voltage which is provided to the first driver D1, the second driver D2 and the third driver D3. The first driver D1, the second driver D2 and the third driver D3 are coupled in parallel at their inputs and provide a parallel power to the light source LED. The controller C provides control signals for the first driver D1, the second driver D2 and the third driver D3. The controller C therefore determines the power that can be delivered to the light source LED. Preferably, the controller C controls the drivers such that the power provided to the light source LED corresponds to the power required for the light source LED according to the discrete dimming levels.

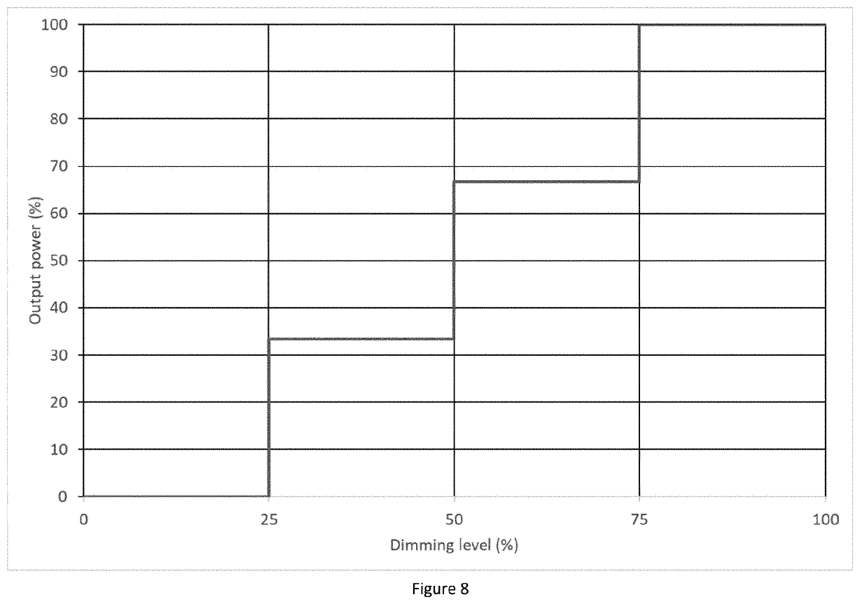

FIG. 8 shows an example of a graph of the relation of the dimming level and the output power of the driver circuit when three drivers are provided. In this example, it is assumed that the drivers have an approximate identical rated power. In this example, four discrete dimming levels are derived, namely 0%, 33.33%, 66.67% and 100%. At a dimming level between 0% and 24%, the discrete dimming level is set at 0%, resulting in no power to be provided to the light source LED. At a dimming level between 25% and 50%, the discrete dimming level is set at 33.33%, resulting in the controller C controlling one driver to provide power to the light source LED at the corresponding rated power of that driver. This results in that 33% of the total power that can be provided by the driver circuit is provided to the light source LED. At a dimming level between 26% and 75%, the discrete dimming level is set at 66.67%, resulting in the controller C controlling two of the three drivers to provide the power to the light source LED at the corresponding rated powers of the drivers. This results in that 66.67% of the total power that can be provided by the driver circuit is provided to the light source LED. At a dimming level between 76% and 100%, the discrete dimming level is set at 100%, resulting in the controller C controlling all drivers to provide power to the light source LED at the corresponding rated powers of the drivers. This results in that 100% of the total power that can be provided by the driver circuit is provided to the light source LED.

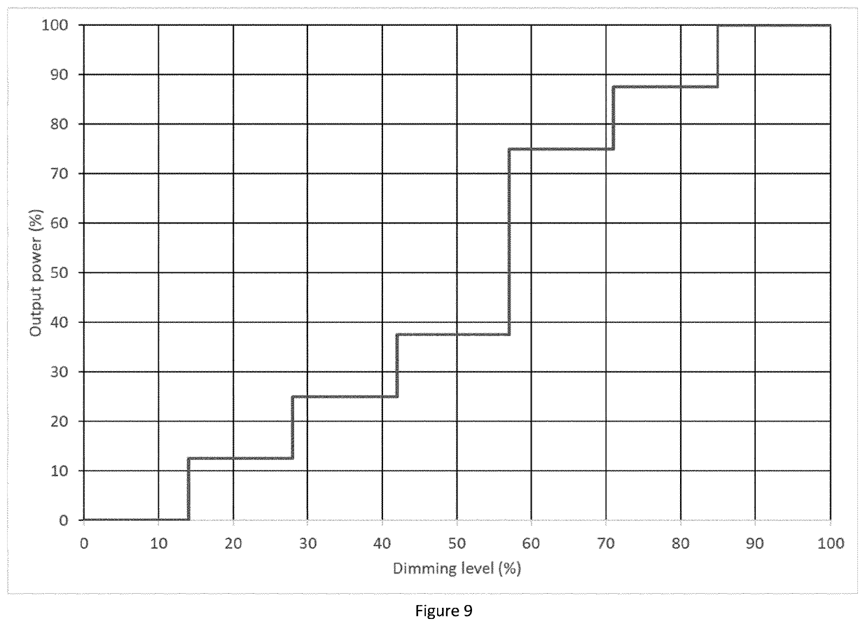

FIG. 9 shows another example of a graph of the relation of the dimming level and the output power of the driver circuit when three drivers are provided. In this example, it is assumed that the drivers have different rated powers. In this example, seven discrete dimming levels are derived, namely one at 0% output power, one at 12.5% output power, one at 25% output power, one at 37.5% output power, one at 75% output power, one at 87.5% output power and the last one at 100% output power. As an example, the first driver D1 may have a rated power of 1 W, the second driver D2 may have a rated power of 2 W and the third driver D3 may have a rated power of 5 W, resulting in a maximum power that can be provided by the driver circuit of 8 W. In this example, at a dimming level between 0% and 14.3%, the discrete dimming level is set at 0%, resulting in no power to be provided to the light source LED. At a dimming level between 14.4% and 28.6%, the discrete dimming level is set at 12.5%, resulting in power to be provided to the light source LED by only the first driver D1 at the rated power of the first driver D1. At a dimming level between 28.7% and 42.9%, the discrete dimming level is set at 25%, resulting in power to be provided to the light source LED by only the second driver D2 at the rated power of the second driver D2. At a dimming level between 43% and 57.1%, the discrete dimming level is set at 37.5%, resulting in power to be provided to the light source LED only by the first driver D1 and the second driver D2 at the rated powers of the first driver D1 and the second driver D2. At a dimming level between 57.2% and 71.4%, the discrete dimming level is set at 75%, resulting in power to be provided to the light source LED by only the first driver D1 and the third driver D3 at the rated powers of the first driver D1 and the third driver D3. At a dimming level between 71.5% and 85.7%, the discrete dimming level is set at 87.5%, resulting in power to be provided to the light source LED by only the second driver D2 and the third driver D3 at the rated powers of the second driver D2 and the third driver D3. At a dimming level between 85.8% and 100%, the discrete dimming level is set at 100%, resulting in power to be provided to the light source LED by first driver D1, the second driver D2 and the third driver D3 at the rated powers of the first diver D1, the second driver D2 and the third driver D3. Changing the rated powers of the drivers will result in different distributions of the discrete dimming levels.

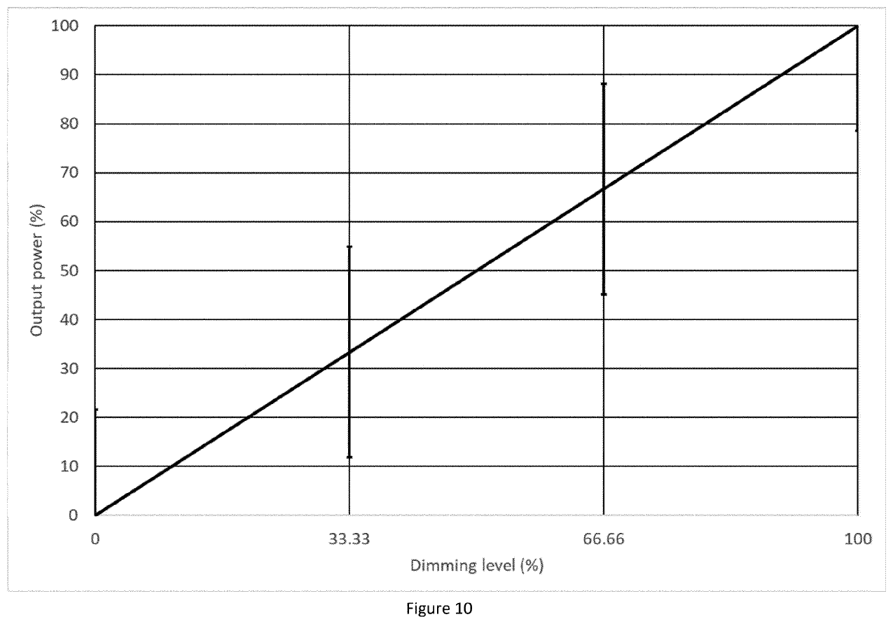

FIG. 10 shows another graph of the relation of the dimming level and the output power of the driver circuit when three drivers are provided. The dimming signal is received by the controller C and is interpreted as a dimming level. The controller determines the discrete dimming levels based on the dimming level. In this example there are four discrete dimming levels, namely one at 0% output power, one at 33.3% output power, one at 66.67% output power and the last one at 100% output power. In this example, the discrete dimming level is used different compared to the previous examples. The discrete dimming level is used to determine whether an additional driver is required to provide power to the light source or if another driver is to be prevented for powering the light source. In this example, it is again assumed that the first driver D1, the second driver D2 and the third driver D3 are arranged to have substantial identical rated powers. At 0%, the controller C controls all drivers to not provide power to the light source LED. At a dimming level between 1% to 33.33%, the controller C controls one of the drivers to allow power to be provided to the light source LED. As an example, at a dimming level of 11.11%, the active driver may be arranged to provide an output power of 33.33% of the driver's rated power and at a dimming level of 33.33%, the active driver may be arranged to provide an output power of 100% of the driver's rated power. At a dimming level of 33.34%, the controller C determines that the discrete dimming level of 33.33% has been exceeded. This means that between the dimming levels 33.34% and 66.67%, one of the drivers provides the rated power of the driver and another driver additionally provides a variable power. At a dimming level of 66.68%, the controller C determines that the discrete dimming level of 66.67% has been exceeded. This means that between the dimming levels 66.68% and 100%, two of the drivers provide the rated power of the driver and a third driver additionally provides a variable power.

As an example, at a dimming level of 77.78%, two drivers provide 100% of the rated power and the driver providing variable power may be arranged to provide an output power of 33.33% of the driver's rated power. At a dimming level of 100%, all drivers may be arranged to provide an output power of 100% of the driver's rated power. The controller C therefore determines the discrete dimming levels and between two discrete dimming levels, one driver is arranged to provide a power to the light source LED that may be variable i.e., the power may be changed based on the dimming level, and another driver, or two drivers depending on the absolute dimming level, is/are arranged to provide their respective rated power to the light source LED.

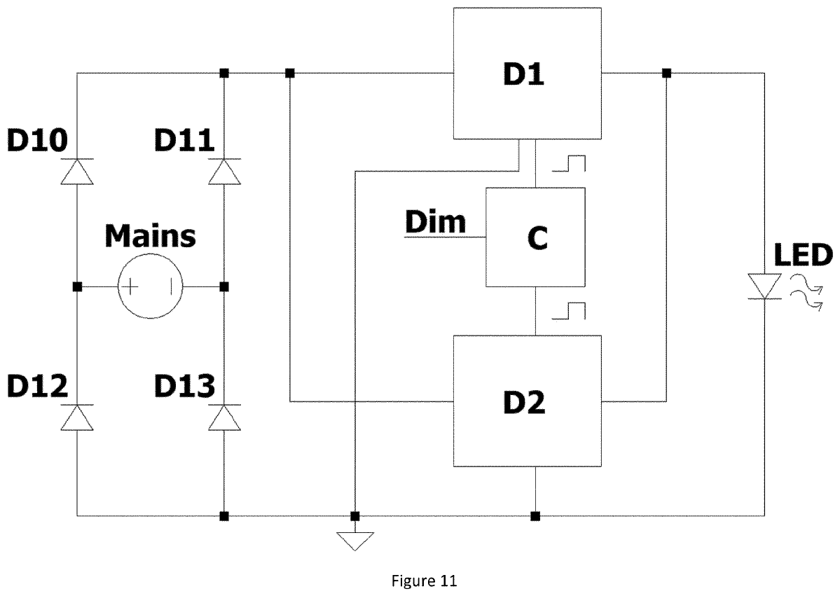

FIG. 11 show another example of a driver circuit. In this example, a rectifier circuit D10, D11, D12, D13 is provided. The rectifier circuit provides a rectified voltage which is provided to the first driver D1 and the second driver D2. The first driver D1 and the second driver D2 are coupled in parallel at their inputs and provide a parallel power to the light source LED. The controller C provides control signals for the first driver D1 and the second driver D2. The controller C may for example provide an enable or disable signal to each of the drivers. The controller C may receive a dimming signal Dim. The dimming signal Dim may be provided by a dimmer or an external device providing dimming commands. Examples of devices that can provide the dimming signal are phase-cut dimmers, 0-10 V dimmers, DALI dimmers, DMX dimmers or wireless remote devices for providing dimming signals. The first driver D1 and the second driver D2 are arranged to provide power to the same load, which is in this example a light source LED. The first driver D1 provides a rated power to the light source LED at an optimum power conversion rate. The first driver D1 therefore provides a first output power at a first optimum power conversion rate. The second driver D2 provides a rated power to the light source LED at an optimum power conversion rate. The second driver D2 therefore provides a second output power at a second optimum power conversion rate. When both drivers are arranged to provide the same amount of power, the first and second output powers may be the same and therefore also the first and second optimum conversion rates may be the same. The controller C may control the on times of the first driver D1 and the second driver D2 at a predefined duty cycle. The duty cycle of the on times may be determined based on the received dimming signal. The controller C converts the dimming signal into a dimming level. Based on the dimming level, a desired output power to the light source LED is required. Providing a first duty cycle for the on time of the first driver D1 and a second duty cycle for the on time of the second driver D2, the controller C can regulate the power to be provided to the light source LED.

As an example, at 0% dimming level, both drivers are turned off. Increasing the dimming level may increase the on-time of the first driver D1 until the first driver has an on-time with a duty cycle of 100%. This may occur at a dimming level of 50%. At the dimming level of 50%, the first driver D1 provides its rated power for 100% of the time. Further increasing the dimming level causes the controller to both enable the first driver D1 and the second driver D2. As an example, the first driver D1 may be controller with an on-time of 100% over the entire range of 50% to 100%. The second driver D2 is then controlled with an increasing on time as the dimming level increases. When the dimming level is at 100%, both the first driver D1 and the second driver D2 are controlled to operate with on-times having a duty cycle of 100%. Effectively both drivers are continuously powering the light source LED at their rated powers.

As another example, the rated power of the first driver D1 may be different from the rated power of the second driver D2.

As an example, the first driver D1 may have a rated power of 2 W. The second driver D2 may have a rated power of 4 W. The maximum total power that can be provided to the light source LED by the driver circuit is then 6 W. When the dimming level is set at 50%, an output power of 3 W may be desired. The controller C may then provide a first duty cycle of 100% for the first driver D1 and a second duty cycle of 25% for the second driver D2. The first driver D1 provides 2 W and the second driver D2 provides 1 W, providing a total of 3 W to the light source LED. Another way of providing the 3 W of power is to provide a first duty cycle of 0% to the first driver D1 and a second duty cycle of 50% to the second driver D2. The first driver D1 provides 0 W to the light source LED and the second driver D2 provides 3 W to the light source LED. It is clear that these examples form examples out of many combinations of duty cycles that can be used to come to the desired output power of the driver circuit.

When the first driver D1 and/or the second drivers D2 is/are arranged to provide power to the light source, this is done at the rated power level. Therefore, providing power to the light source is done with a high efficiency. It is an insight of the inventors that in order to achieve the highest efficiency, a driver should provide power to a load at a single rated power level. Deviating from this power level has as a result that the efficiency is reduced. Providing a duty cycle in the rated power to the load allows less power to be provided to load, while keeping the efficiency high.

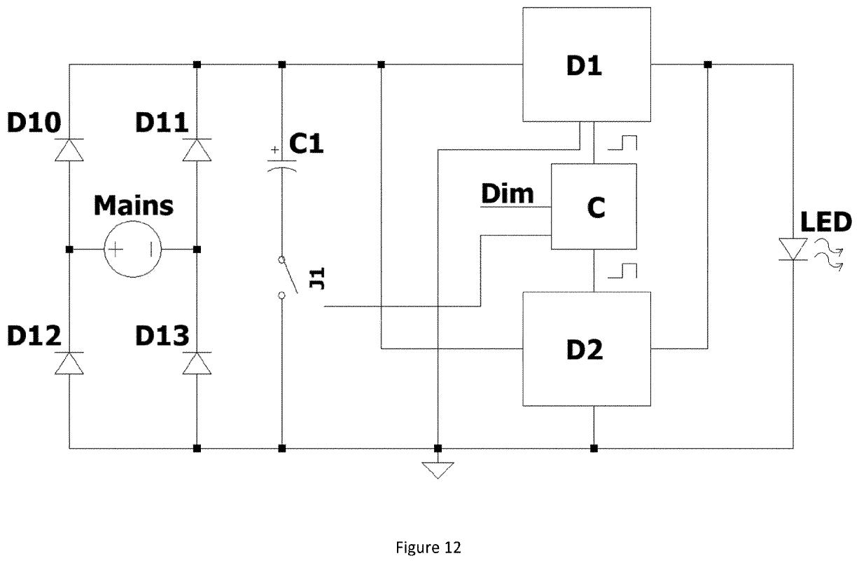

FIG. 12 shows a further example of a driver circuit. The driver circuit may be similar to the driver circuit shown in FIG. 11. In this example, a rectifier circuit D10, D11, D12, D13 is provided. The rectifier circuit provides a rectified voltage which is provided to the first driver D1 and the second driver D2. The first driver D1 and the second driver D2 are coupled in parallel at their inputs and provide a parallel power to the light source LED. The controller C provides control signals for the first driver D1 and the second driver D2. The controller C may for example provide an enable signal to each of the drivers. The controller C may receive a dimming signal Dim. The dimming signal Dim may be provided by a dimmer or an external device providing dimming commands. Examples of devices that can provide the dimming signal are phase-cut dimmers, 0-10 V dimmers, DALI dimmers, DMX dimmers or wireless remote devices for providing dimming signals. The first driver D1 and the second driver D2 are arranged to provide power to the same load, which is in this example a light source LED. The first driver D1 provides a rated power to the light source at an optimum power conversion rate. The first driver D1 therefore provides a first output power at a first optimum power conversion rate. The second driver D2 provides a rated power to the light source at an optimum power conversion rate. The second driver D2 therefore provides a second output power at a second optimum power conversion rate. When both drivers are designed to provide the same amount of power, the first and second output powers may be the same and therefore also the first and second optimum conversion rates may be the same. The controller C may control the on times of the first driver D1 and the second driver D2 at a predefined duty cycle. The duty cycle of the on times may be determined based on the received dimming signal. The controller C converts the dimming signal into a dimming level. Based on the dimming level, a desired output power is required. Providing a first duty cycle for the on time of the first driver D1 and a second duty cycle for the on time of the second driver D2, the controller C can regulate the power to be provided to the light source LED.

Preferably, the control of the on-time is performed using pulse width modulation, PWM. The frequency of the PWM signals is at a frequency that is above a perceivable frequency for the human eye e.g., 200 Hz. More preferably, the frequency is above 1 kHz. There can be filter capacitors connected in parallel with the LED for achieving a smooth current through the LED load.

When the first driver D1 and/or the second drivers D2 is/are arranged to provide power to the light source, this is done at the rated power level. Therefore, providing power to the light source is done with a high efficiency. It is an insight of the inventors that in order to achieve the highest efficiency, a driver should provide power to a load at a single rated power level. Deviating from this power level has as a result that the efficiency is reduced. Providing a duty cycle in the rated power to the load allows less power to be provided to load, while keeping the efficiency high.

A series configuration of a buffer capacitor C1 and a switch J1 may be provided at the output of the rectifier circuit D10, D11, D12, D13. The switch is shown as a simple controllable switching element, but additional circuit may be provided for performing the required functions i.e., controlling the flow of current through the buffer capacitor C1. This means that instead of a switch, a switching device may be used having one or more switching elements and control circuitry. The switch J1 may be controller by the controller C. The switch J1 is used to regulate a current through the buffer capacitor C1. This allows the buffer capacitor C1 to be charged and discharged in a controlled manner. Controlling the drivers with the duty cycle control may cause disturbances at the input of the driver circuit because there are moments in time that the driver is not drawing a current from the mains. The buffer capacitor C1 may be used to draw a current from the mains when no or not enough current is drawn by any of the drivers. This allows the current from the mains to be smoothened. Preferably, the controller C controls the switch J1 and the driver such that the driver circuit provides power factor correction. This means that the current drawn from the mains is following the waveform of the voltage. The mains voltage may e.g. be a sinus at a frequency of 50 Hz or 60 Hz. The waveform of the current is then such that the waveform follows this voltage waveform in phase. This can also be achieved by having a common input PFC (Power Factor Correction) stage placed between the rectifier and the driver D1 and D2. The common PFC stage draws a sinusoidal current from the mains and a buffer capacitor placed at the output of the PFC stage acts as a buffer for the pulsating current drawn by the driver D1 and D2.

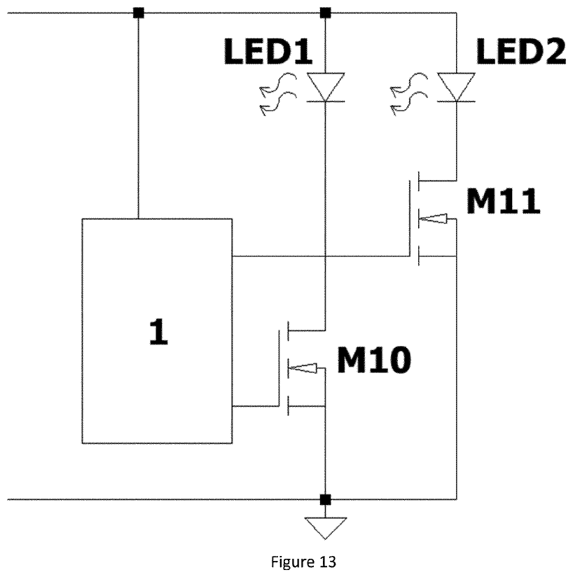

FIG. 13 shows an example of a circuit diagram where an improved light source LED is provided that can operate with the driver circuit as provided in the examples. The light source LED receives power from the driver circuit. The light source LED has a first LED load LED1 and a second LED load LED2. The first LED load LED1 and the second LED load LED2 are coupled in parallel. Preferably, the first LED load LED1 and the second LED load LED2 have an approximately identical forward voltage. Preferably, the first LED load LED1 and the second LED load LED2 are provided as filaments. The first LED load LED1 and the second LED load LED2 are shown as single LEDs but more LEDs can be coupled in series as to form a string of LEDs or a filament. A first series switch M10 is provided in series with the first LED load LED1. A second series switch M11 is provided in series with the second LED load LED2. A control circuit 1 is arranged to control the first series switch M10 and the second series switch M11. The control circuit is arranged to sense a parameter of the voltage or current provided by the driver circuit. Examples of the parameters may be a frequency, a duty cycle or an amplitude of the voltage or current. The parameter is used by the control circuit 1 to determine how the first series switch M10 and the second series switch M11 are controlled. As an example, a frequency modulation on the voltage or current provided by the driver circuit may provide information for the control circuit 1 to determine which of the series switches is to be controlled. As an example, a frequency modulation of 1 kHz may provide an indication for the control circuit 1 to close the first series switch M10 and open the second series switch M11, where a 2 kHz modulation may cause the first series switch M10 to open and the second series switch M11 to close and a 3 kHz modulation may cause the first series switch M10 to close and the second series switch M11 to close. As another example, a similar control can be provided by changing the amplitude of the voltage or the current provided by the driver circuit. A change in voltage or current may change the control of the first series switch M10 and the second series switch M11. An advantage of control of the light source LED configuration according to the above-mentioned examples is that with only two wires, power and data can be sent from the driver circuit to the light source, which is especially beneficial when the light source LED is designed as a filament in a bulb, such as a retrofittable bulb with e.g. a screw or bayonet base. In such situation, the number of wires that can be provided through the stem may be limited. Using the dimming technique provided in the examples allow an easy dimming of the filaments, while the control circuit 1 allows to distribute the provided power among the filaments. Preferably, the first LED load LED1 and the second LED load LED2 have different colours or colour temperatures from each other. Preferably, the first LED load LED1 has a warm colour temperature and the second LED load LED2 has a cold colour temperature. The parameter can therefore be used to allow the control circuit 1 to regulate the colour or colour temperature that is emitted by the light source LED. The opening and closing of the first series switch M10 and the second series switch M11 can be a time continuous process where either the first series switch M10 is closed or the second series switch M11 is closed, each with their own duty cycle e.g., a PWM control. Preferably, this switching process is performed with a frequency above 100 Hz and more preferably above 2 kHz. Alternatively, to provide for a simple control for the control circuit 1, the opening and closing of the first series switch M10 and the second series switch M11 can be a single event, e.g. at start-up of the lighting apparatus. During operation, the open or closed state of the first series switch M10 and the second series switch M11 can be altered by a different command, e.g. a command for changing the colour or colour temperature.

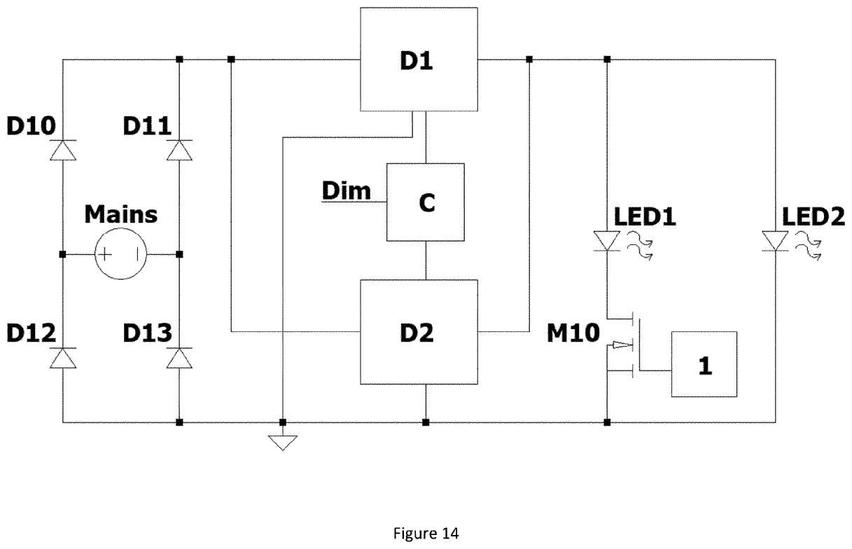

FIG. 14 shows a circuit diagram of a lighting apparatus with a simpler example of an improved light source LED that can operate with the driver circuit as provided in the examples. The light source LED receives power from the driver circuit. The light source LED has a first LED load LED1 and a second LED load LED2. The first LED load LED1 and the second LED load LED2 are coupled in parallel. Preferably, the first LED load LED1 has a forward voltage that is lower than the forward voltage of the second LED load LED2. Preferably, the first LED load LED1 and the second LED load LED2 are provided as filaments. The first LED load LED1 and the second LED load LED2 are shown as single LEDs but more LEDs can be coupled in series as to form a string of LEDs or a filament. A first series switch M10 is provided in series with the first LED load LED1. A control circuit 1 is arranged to control the first series switch M10. The control circuit is arranged to sense a parameter of the voltage or current provided by the driver circuit. Examples of the parameters may be a frequency, a duty cycle or an amplitude of the voltage or current. The parameter is used by the control circuit 1 to determine how the first series switch M10 is controlled. As an example, a frequency modulation on the voltage or current provided by the driver circuit may provide information for the control circuit 1 to control the first series switch M10. As an example, a frequency modulation may provide an indication for the control circuit 1 to close the first series switch M10, where an absence of the modulation may provide an indication for the control circuit 1 to open the first series switch M10. When the first series switch M10 is open, the current provided by the driver circuit can only flow through the second LED load LED2. When the first series switch M10 is open, the current provided by the driver circuit can flow through the first LED load LED1. When the forward voltage of the first LED load LED1 is approximately identical to the forward voltage of the second LED load LED2, the closing of the first series switch M10 will allow a current to flow through both the first LED load LED1 and the second LED load LED2. If the forward voltage of the first LED load LED1 is lower than the forward voltage of the second LED load LED2, the current will only flow through the first LED load LED1. As another example, a similar control can be provided by changing the amplitude of the voltage or the current provided by the driver circuit. A change in voltage may change the control of the first series switch M10. An advantage of control of the light source LED configuration according to the above-mentioned examples is that with only two wires, power and data can be sent from the driver circuit to the light source, which is especially beneficial when the light source LED is designed as a filament in a bulb, such as a retrofittable bulb with e.g. a screw or bayonet base. In such situation, the number of wires that can be provided through the stem may be limited. Using the dimming technique provided in the examples allow an easy dimming of the filaments, while the control circuit 1 allows to distribute the provided power among the filaments. Preferably, the first LED load LED1 and the second LED load LED2 have different colours or colour temperatures from each other. Preferably, the first LED load LED1 has a warm colour temperature and the second LED load LED2 has a cold colour temperature. The parameter can therefore be used to allow the control circuit 1 to regulate the colour or colour temperature that is emitted by the light source LED. The opening and closing of the first series switch M10 can be a time continuous process where the first series switch M10 is open or closed with a duty cycle e.g., a PWM control. Preferably, this switching process is performed with a frequency above 100 Hz and more preferably above 2 kHz. Alternatively, to provide for a simple control for the control circuit 1, the opening and closing of the first series switch M10 can be a single event, e.g. at start-up of the lighting apparatus. During operation, the open or closed state of the first series switch M10 can be altered by a different command, e.g. a command for changing the colour or colour temperature.

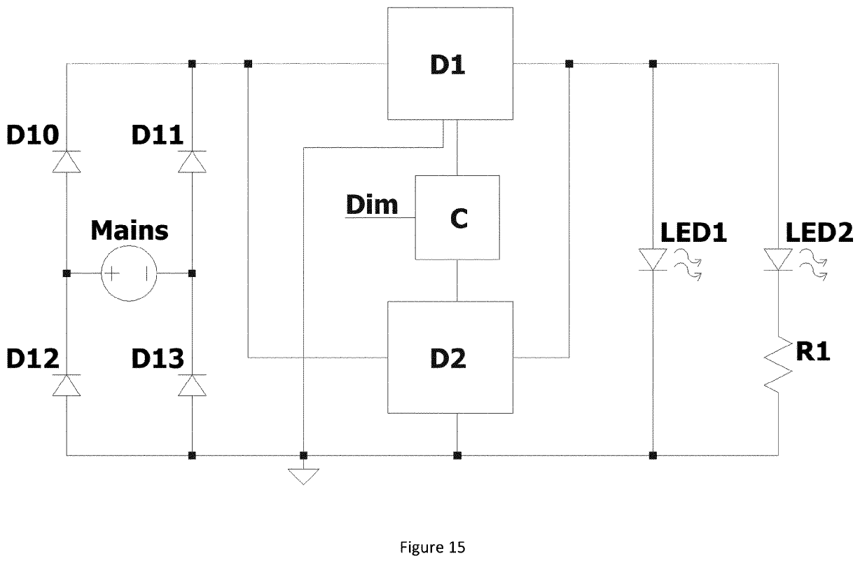

FIG. 15 shows a circuit diagram of a lighting apparatus with a further simple example of an improved light source LED that can operate with the driver circuit as provided in the examples. The light source LED receives power from the driver circuit. The light source LED has a first LED load LED1 and a second LED load LED2. The first LED load LED1 and the second LED load LED2 are coupled in parallel. Preferably, the first LED load LED1 has a forward voltage that is higher than the forward voltage of the second LED load LED2. A resistor R1 is placed in series with the second LED load LED2. The driver circuit as provided in the examples provides a current that may vary based on the amount of drivers that provide the power to the light source. At a relatively low current, all current will flow through the second LED load LED2 and resistor R1. The sum of the forward voltage of the second LED load LED2 and the voltage drop over the resistor R1 is lower than the forward voltage of the first LED load LED1. If the current increases, the forward voltage of the second LED load LED2 will only increase slightly, but a more significant voltage will drop over the resistor R1. Further increasing the current to the light source LED will cause the sum of the forward voltage of the second LED load LED2 and the voltage drop over the resistor R1 to increase until this sum reaches or exceeds the forward voltage of the first LED load LED1. At his increased current, the first LED load LED1 will also start conducting. Increasing or decreasing the current to the light source therefore allows a simple distribution of the current through the first LED load LED1 and the second LED load LED2 to be achieved. Preferably, the first LED load LED1 is a cold white LED load and the second LED load LED2 is a warm white LED load. At a low current, mainly the warm white LEDs are active while at an increased current, the cold white LEDs also become active. This allows for a very simple mimicking of a dimmable incandescent filament or halogen lamp. Compared to the examples provided in FIGS. 13 and 14, this circuit does not require a control circuit 1 although additional power losses may be created by the resistor R1.

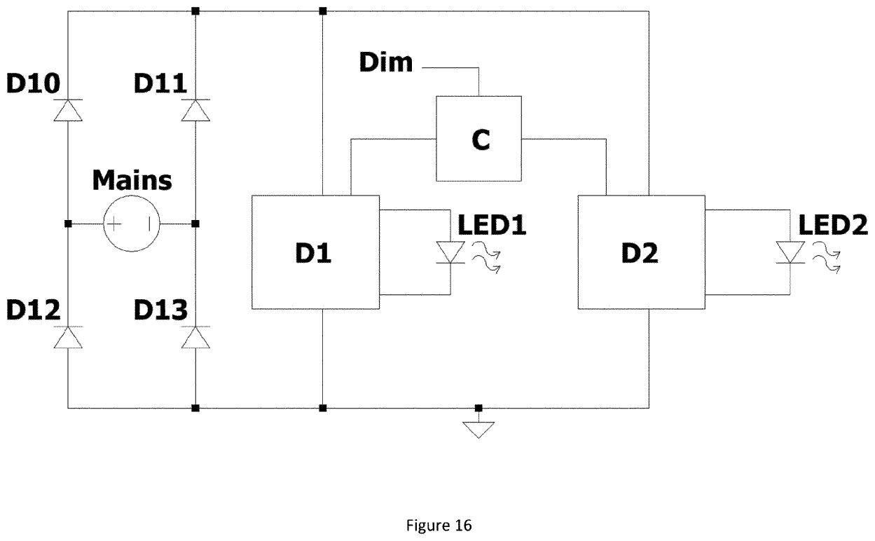

FIG. 16 shows another example of a lighting apparatus. In the example provided, a rectifier circuit D10, D11, D12, D13 is provided. The rectifier circuit provides a rectified voltage which is provided to the first driver D1 and the second driver D2. The first driver D1 provides a regulated power to a first light source LED1. The second driver D2 provides a regulated power to a second light source LED2. A controller C is used to control the first driver D1 and the second driver D2. The controller C may receive a dimming signal Dim. The dimming signal Dim may be provided by a dimmer or an external device providing dimming commands. Examples of devices that can provide the dimming signal are phase-cut dimmers, 0-10 V dimmers, DALI dimmers, DMX dimmers or wireless remote devices for providing dimming signals. The first driver D1 is arranged to provide a regulated current to the first light source LED1. The current amplitude is set at a value that matches the current density through the first light source LED1 that allows for an optimum conversion of electric energy into photonic energy. An LED has an optimum current density, where at this current density, the electric power provided to the LED is converted into light in its most efficient way. The LED therefore has a highest efficacy at the optimum current density. Increasing the current density in the LED from the optimum current density e.g. by increasing the current amplitude through the LED, the light output will increase but the light efficacy will be reduced. Decreasing the current density in the LED from the optimum current density e.g. by decreasing the current amplitude through the LED, the light output will decrease and the light efficacy will also be reduced. It is therefore desired to allow the driver to provide a current to the LED load that corresponds with the optimum current density of the LED. The first driver D1 provides a current that allows the current density in the first light source LED1 to approach the optimum current density. The closer the current density approaches the optimum current density, the more efficient the first light source LED1 becomes. The second driver D2 provides a current that allows the current density in the second light source LED2 to approach the optimum current density. The closer the current density approaches the optimum current density, the more efficient the second light source LED2 becomes. To further optimize the efficiency of the lighting apparatus, the drivers are optimized to provide the current that allows the light sources to be operated at their optimized current densities. The optimized current density for a light source as an LED is considered to be one value and therefore, a fixed current is desired to be provided to the light sources. The fixed current may be varied to compensate for changes in the value of the optimum current density. As an example, the optimum current density may change based on the temperature or lifetime of the light sources. By optimizing the design of the drivers at the desired currents for the optimum current densities, the drivers operate at their highest efficiency and the light source provide light at their highest efficiency. The first driver D1 is therefore adapted to provide a current at its rated power level to the first light source LED1 and the second driver D2 is adapted to provide a current at its rated power level to the second light source LED2. The first light source LED1 and the second light source LED2 may be of different dimensions. The forward voltage and/or the required current of the first light source LED1 is therefore different from the second light source LED2. Alternatively, the first light source LED1 and the second light source LED2 may have identical electrical properties. If the controller C receives a dimming signal, the controller may decide to activate a number of drivers based in the dimming level. At e.g. a dimming level of 50%, the controller may then decide to activate one of the drivers so that one of the light sources is activated. As an example, the first driver D1 may provide the current at its rated power level to the first light source LED1 and the second driver D2 may then not provide any current to the second light source LED2. This allows the lighting apparatus to provide 50% of the possible light that can be generated still at a very high efficiency. Similar to the other examples, more driver with light source combinations may allow more dimming steps to be introduced while operating the lighting apparatus at highest efficiency possible.

In the examples provided, the controller C, and additional peripheral electrical components, may also be powered using a dedicated power supply. An auxiliary power supply may be provided that is used to power the controller C. Preferably, the auxiliary power supply is electrically isolated from the light source LED. The auxiliary power supply is therefore a dedicated power supply for the controller C. The auxiliary power supply is not able to provide power to the light source LED and therefore can be optimized for powering the controller C.

During a stand-by mode of the lighting apparatus, no power is to be provided to the light source LED and therefore the drivers can be turned off. The controller C may however be required to operate in a stand-by mode for e.g. receiving control commands for activating the lighting apparatus. The controller C then requires less power than during the operation mode of the lighting apparatus. A further auxiliary power supply may be provided to power the controller C and peripheral electrical components during the standby. The further auxiliary is optimized for powering the controller C in the stand-by mode.

Under the definition of rated power, it could be understood that the driver has a defined power capability. At this power capability, the driver provides the power to the light source LED in a most efficient way. The driver's design is then optimized to allow the highest efficiency to be achieved at this rated power level. The rated power may be at a power that is at the maximum power that the driver can provide. Alternatively, the rated power may be below the maximum power level. When the driver provides a power that is different from the rated power, e.g. higher or lower than the rated power, the efficiency of the driver will be reduced. For maximum efficiency, it is therefore desired to operate the driver at its rated power whenever the driver is required to provide power to the light source LED.

In the examples provided the drivers may be separate devices with separate components. To improve the use of space and components, some components may be re-used among the drivers.

In the examples provided, the dimming levels relate linearly with the power required for the light source LED. Other relations such as a logarithmic or non-linear may also be conceivable and lead to the desired effects.

In the examples provided, for the sake of simplicity, the discrete dimming levels are evenly distributed over the entire dimming range. It is to be understood that this merely one option of converting the dimming level into discrete dimming steps.

Alternatively, the discrete dimming steps may be distributed such that at a low dimming sub-range, more discrete dimming steps are provided than at a high dimming sub-range, or vice versa.

Under dimming level, it is understood how much of the power is required to be provided to the load by the driver circuit. At a dimming level of 100%, It is desired that the driver circuit provides 100% of its rated power. At a dimming level of 0%, it is desired that the driver circuit provides 0% of its rated power. The dimming levels in between 100% and 0% can be scaled linear or non-linear to the rated power of the driver circuit. In a linear scaling, a dimming level of 50% may relate to 50% of the rated power of the driver circuit. In a non-linear scaling, a dimming level of 50% may e.g. relate to 25% of the rated power of the driver circuit.

The examples provided show the use of two drivers or three drivers. It is clearly to be understood that more drivers can be used. Furthermore, the more drivers are used, the more discrete dimming steps can be provided.

The drivers may be provided as switched mode power supplies. Examples of switched mode power supplies are boost converters, buck converters, buck-boost converters, flyback converter or resonant converters.

The definition of dimmable in the context of a dimmable driver is to be understood according to common practice. A dimmable driver is capable of receiving a dimming signal such as 0-10 V, wireless dimming commands or a phase-cut dimming signal. A non-dimmable driver may not be able to receive any dimming signal and will therefore always provide a fixed output current and/or voltage. A dimmable driver allows the light source to be dimmed as a lower power provided to the light source will result in a lower light output.

The light source LED may be considered as a single light source LED, having an input and a return. Both drivers provide power to the input and return.

Other variations to the disclosed embodiments can be understood and effected by those skilled in the art in practicing the claimed invention, from a study of the drawings, the disclosure, and the appended claims. In the claims, the word “ ” comprising “ ” does not exclude other elements or steps, and the indefinite article “ ” “ ” or “ ” a″” does not exclude a plurality. The mere fact that certain measures are recited in mutually different dependent claims does not indicate that a combination of these measures cannot be used to advantage. Any reference signs in the claims should not be construed as limiting the scope.

1. A driver circuit for driving a light source, the driver circuit comprising:
a first driver adapted to provide a first maximum amount of power to the light source;
a second driver adapted to provide a second maximum amount of power to the light source(S);
a controller for controlling the first driver and the second driver;
wherein the controller is arranged to receive a dimming signal indicative of a dimming level for the light source,
wherein the controller is arranged to convert the received dimming signal into a number of discrete dimming levels representing dimming levels corresponding to the first maximum amount of power provided by the first driver and/or the second maximum amount of power provided by the second driver, wherein the controller is arranged to allow or deny a power to flow from the first driver and/or the second driver based on the discrete dimming levels.

2. The driver circuit according to claim 1, further comprising a third driver, wherein the controller is arranged to control the third driver and wherein each discrete dimming level represents a dimming level corresponding to an amount of power that can be provided by the first driver and/or the second driver and/or the third driver wherein the controller is arranged to allow or deny a power to flow from the first driver and/or the second driver and/or the third driver based on the received dimming signal.

3. The driver circuit according to claim 1, wherein the first driver and the second driver are arranged to have identical rated powers.

4. The driver circuit according to claim 1, wherein the first driver and the second driver are arranged to have different rated powers from each other.

5. The driver circuit according to claim 1, wherein between two discrete dimming levels, only one driver is arranged to provide a variable power to the light source based on the dimming signal.

6. The driver circuit according to claim 1, wherein the first driver and/or the second driver are non-dimmable.

7. The driver circuit according to claim 1, wherein the controller is arranged for turning on and off the first driver and the second driver based on the discrete dimming level.

8. The driver circuit according to claim 1, wherein the first driver and/or the second driver are dimmable, wherein the first driver and/or the second driver are adapted to be dimmed down to a minimum output power of 50%.

9. The driver circuit according claim 1, wherein the first driver and/or the second driver are dimmable switched mode power supplies wherein the first driver and/or the second driver are adapted to be dimmed down such that a total efficiency of the driver circuit does not fall below 95%.

10. The driver circuit according to claim 1, further comprising an auxiliary driver, adapted to power the controller and adapted to be electrically separated from the light source.

11. The driver circuit according to claim 1, further comprising a further auxiliary driver, wherein the further auxiliary driver is adapted to power the controller when the driver circuit is in a standby mode.

12. The driver circuit according to claim 1, wherein at a discrete dimming level, where the first driver and the second driver provide power to the lighting load, the first driver and the second driver operate in an interleaved mode of operation.

13. A lighting apparatus comprising:
the driver circuit according to claim 1; and
the light source.

14. The lighting apparatus according to claim 12, wherein the lighting load is a semiconductor lighting load.
